(19) United States
(12) Patent Application Publication
(10) Pub. No.: US 2005/0134807 A1
(43) Pub. Date: Jun. 23, 2005

(54) Projection lens unit and projection system employing the same

(75) Inventor: Jong-soo Lee, Cheonan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/010,377

(22) Filed: Dec. 14, 2004

(30) Foreign Application Priority Data
Dec. 23, 2003 (KR) 2003-95408

(51) Int. Cl. G03B 21/14; G03B 21/28

(52) U.S. Cl. 353/77

(57) ABSTRACT

Provided are a projection lens unit that enables a reduction in the thickness of a projection system and a projection system employing the same. The projection lens unit includes a refractive optical unit including a plurality of lenses that enlarge and project an image produced by a display and a reflective optical unit including at least one reflecting mirror slanted with respect to the minor axis of the screen, the reflective optical unit reflecting the image passing through the refractive optical unit toward the screen. The projection lens unit does not interfere with a beam when the thickness of the projection system is decreased. Therefore, a projection system with a slim design as well as a large screen can be provided.

### BACKGROUND OF THE INVENTION

This application claims the priority of Korean Patent Application No. 2003-95408, filed on Dec. 23, 2003, in the Korean Intellectual Property Office, the disclosure of which is incorporated herein in its entirety by reference.

1. Field of the Invention

The present invention relates to a projection lens unit that can be used in a projection system with a small thickness with respect to a screen size and a projection system employing the same.

2. Description of the Related Art

As the demand for projection systems with large screens, high resolution, and slim designs has increased, research has been actively conducted to satisfy these requirements. To achieve a slim projection system, a projection lens unit must generate a thin frustum of a bundle of light rays. However, when the projection lens unit is located at the center of a screen, the frustum of a bundle of light rays can only be reduced to a limited degree. Thus, to achieve a thin frustum, the projection lens unit should be disposed obliquely on the lower portion of the screen.

Other various techniques are being developed for projection systems with large screens and slim designs. However, it is difficult to realize both a large screen and a slim design. That is, since a projection lens unit that projects an image onto the screen tends to become bulkier as the size of the screen increases, it is technically difficult to reduce the thickness of a projection display while increasing the size of a screen.

Referring to FIG. 1, a conventional projection system disclosed in U.S. Patent Publication No. 2002/0071186 A1 includes a light source (not shown), a refracting lens group GL, a first mirror M1 that reflects a beam exiting the refracting lens group GL, a second mirror M2 that reflects the beam reflected from the first mirror M1 upward, and a third mirror M3 that reflects the beam reflected from the second mirror M2 toward a screen 12. The projection lens system also includes a first image plane 11, a prism PR, and an aperture ST.

The refracting lens group GL extends parallel to the screen 12, and the first mirror M1 is at a 45 degree angle to the screen 12 such that a beam emerging from the refracting lens group GL is reflected 90 degrees toward the screen 12. Typically, a screen has an aspect ratio of 4:3 or 16:9 where the longer direction and the shorter direction are a major axis direction L and a minor axis direction S, respectively. FIG. 2 is a schematic drawing of a projection system in which the distance between the screen 12 and the third mirror M3 is less than that of the projection system shown in FIG. 1.

Referring to FIG. 2, since the first mirror M1 is inclined at 45 degrees to the major axis direction L, light reflected from the second mirror M2 may be intercepted by the first mirror M1, as indicated by a portion A. This is because the first mirror M1 has a major axis (longer axis) disposed in a path of light reflected from the second mirror M2 toward the direction in which the first mirror M1 is slanted, that is, the major axis direction L of the first mirror M1.

That is, since the first mirror M1 is disposed such that its major axis is disposed in a light propagation path, the first mirror M1 intercepts most of the light reflected from the second mirror M2 than when the minor axis of the first mirror M1 disposed in the light propagation path. Thus, reducing the thickness of the projection system configured by moving the screen 12 closer to the third mirror M3 makes it more likely that the beam reflected from the second mirror M2 is intercepted by the first mirror M1. A projection system having an aspect ratio of 16:9 has a higher possibility that the beam reflected from the second mirror M2 is intercepted by the first mirror M1 than a projection system having an aspect ratio of 4:3 because the first mirror M1 also has an aspect ratio of 16:9 and the major axis of the first mirror M1 is disposed in a path of the light reflected from the second mirror M2.

As described above, in the conventional projection system shown in FIG. 2, the beam reflected from the second mirror M2 is obstructed by the first mirror M1. This problem becomes worse as the thickness of the projection system decreases. Thus, the conventional projection system has problems when its thickness is reduced.

### SUMMARY OF THE INVENTION

Illustrative, non-limiting embodiments of the present invention overcome the above disadvantages and may overcome other disadvantages not listed above. The present invention provides a projection lens unit that can be used in a projection system with a slim design by reducing the thickness of the projection system with respect to a screen size as much as possible and a projection system employing the same.

According to an aspect of the present invention, there is provided a projection lens unit for enlarging and projecting a beam onto a screen having a major axis and a minor axis including: a refractive optical unit including a plurality of lenses that enlarge and project an image produced by a display; and a reflective optical unit including at least one reflecting mirror slanted toward the minor axis of the screen, the reflective optical unit reflecting the image passing through the refractive optical unit toward the screen.

Optical axes of the refractive optical unit and the reflective optical unit are coplanar. The optical axes of the refractive optical unit and the reflective optical unit are in a plane perpendicular to the major axis of the screen. Each of the at least one reflecting mirror has a short side slanted toward the minor axis of the screen.

The refractive optical unit includes first and second lens groups, and the reflective optical unit includes: a first reflecting mirror that is disposed in an optical path between the first and second lens groups and changes the path of a beam passing through the first lens group; and a second reflecting mirror that is slanted toward the minor axis of the screen and reflects a beam passing through the second lens group.

According to another aspect of the present invention, there is provided a projection system in which an image produced by a display is enlarged and projected by a projection lens unit and focused onto a screen having a major axis and a minor axis. The projection lens unit includes a refractive optical unit including a plurality of lenses that enlarge and project the image and a reflective optical unit including at least one reflecting mirror slanted toward the minor axis of the screen, the reflective optical unit reflecting the image passing through the refractive optical unit toward the screen.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a projection system disclosed in U.S. Patent Publication No. 2002/0071186 A1;

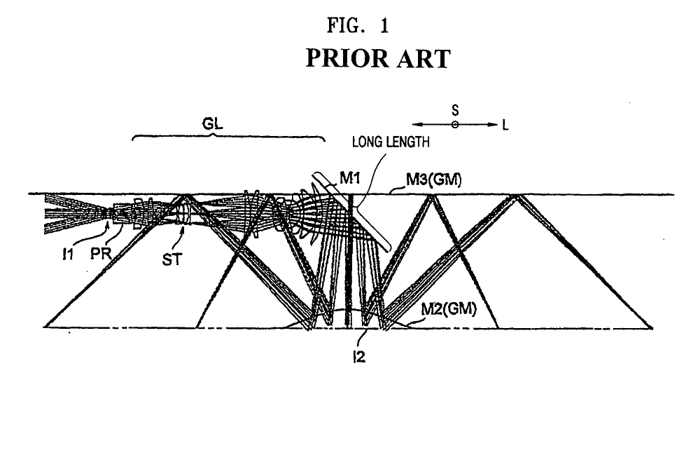

FIG. 2 illustrates a beam being obstructed by a reflective mirror when the thickness of the projection lens unit of FIG. 1 is reduced;

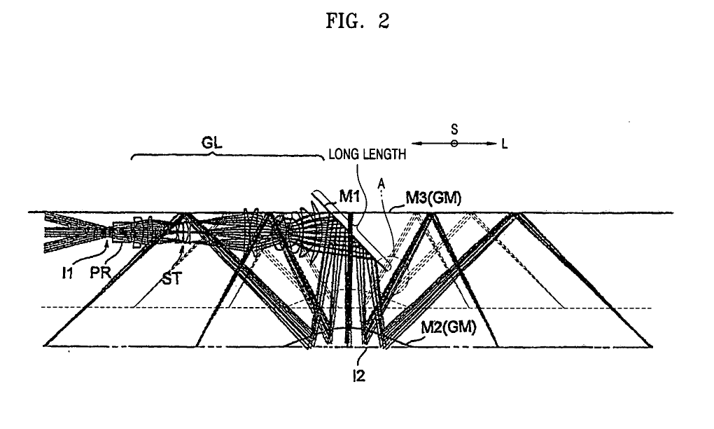

FIG. 3 is a side view of a projection lens unit according to an embodiment of the present invention;

FIG. 4 is a plan view of the projection lens unit illustrated in FIG. 3;

FIG. 5 is a schematic diagram of a projection lens unit including the refractive and reflective optical systems arranged in a different manner than those in FIG. 3; and

FIG. 6 is a schematic diagram of a projection system including the projection lens unit of FIG. 3 according to an embodiment of the present invention.

### DETAILED DESCRIPTION OF THE INVENTION

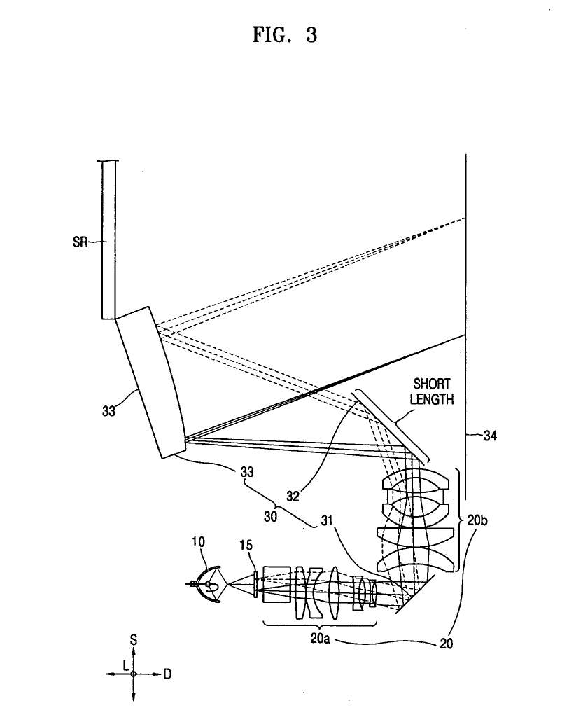

Referring to FIG. 3, a projection lens unit according to an illustrative, non-limiting embodiment of the present invention includes a refractive optical unit 20 including a plurality of lenses that enlarge an image produced by a display 15 for projection and a reflective optical unit 30 including one or more reflecting mirrors that reflect the image at an appropriate angle toward a screen SR.

The display 15 modulates a beam emitted from a light source 10 according to image information and produces an image. The refractive optical unit 20 may include a plurality of lenses or lens groups arranged depending on available installation space. For example, the refractive optical unit 20 may be comprised of a first lens group 20 and a second lens group 20b. In this case, the first lens group 20a is arranged in a thickness direction D of a projection system including the projection lens unit and the second lens group 20b is arranged in a minor axis direction S of the screen SR.

The reflective optical unit 30 may include one or more reflecting mirrors, and FIG. 3 shows an example in which the reflective optical unit 30 includes first through third reflecting mirrors 31 through 33. The first reflecting mirror 31 is disposed in an optical path between the first lens group 20a and the second lens group 20b and changes the path of light emitted from the first lens group 20a toward the second lens group 20b. If the first reflecting mirror 31 is properly installed according to the entire lengths of the first and second lens groups 20a and 20b, the length of the refractive optical unit 20 in the thickness direction D of the projection system can be adjusted.

The light reflected from the first reflecting mirror 31 passes through the second lens group 20b and is reflected by a second reflecting mirror 32 toward a third reflecting mirror 33. The second reflecting mirror 32 can have a shorter side tilted in the minor axis direction S. The third reflecting mirror 33 is an aspheric mirror that corrects image distortion. The light reflected from the third reflecting mirror 33 is reflected by a fourth reflecting mirror 34 and is focused onto the screen SR.

In the present embodiment, the refractive optical unit 20 includes the first and second lens groups 20a and 20b and the first reflecting mirror 31 is disposed in the optical path between the first and second lens groups 20a and 20b. However, the projection lens unit may not include the first reflecting mirror 31 when the refractive optical unit 20 is arranged obliquely to the thickness direction D such that the light passing through the refractive optical unit 20 is directly incident onto the second reflecting mirror 32.

That is, the first reflecting mirror 31 is required only when the propagation path of light must be changed according to the arrangement of the refractive optical unit 20. When the first and second lens groups 20a and 20b are disposed as in FIG. 3, the first and second reflecting mirrors 31 and 32 form identical angles with the fourth reflecting mirror 34, symmetrically about the second lens group 20b.

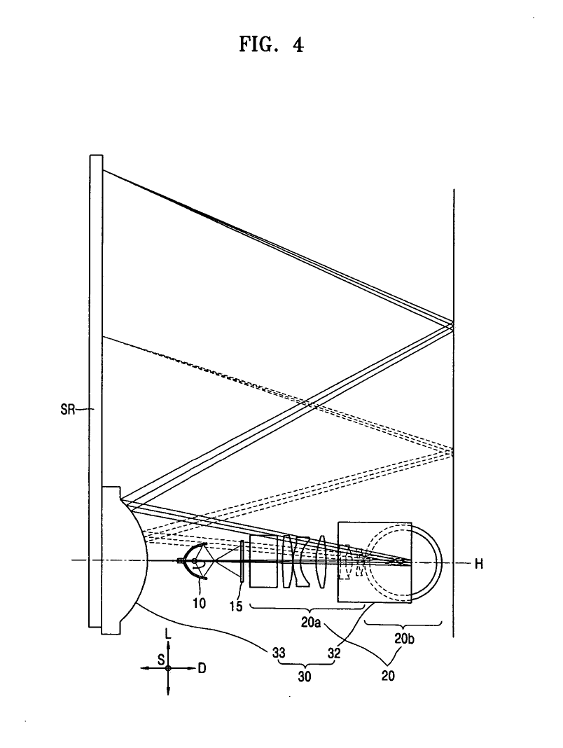

The optical axes of the refractive optical unit 20 and the reflective optical unit 30 are coplanar. Referring to FIG. 4, which is a plan view of the projection lens unit of FIG. 3, the optical axes of the refractive optical unit 20 and the reflective optical unit 30 are in the same plane H, parallel to the minor axis of the screen SR. Since the projection lens unit is symmetric with respect to the plane H, FIG. 4 illustrates only half of the screen SR.

Further, optical axes of the light source 10 and the display 15 may be disposed in the plane H, thereby making optical alignment of the projection lens unit easier.

While the refractive optical unit 20 is circularly symmetric, the reflective optical unit 30 is planar symmetric. The projection lens unit is symmetric about a plane perpendicular to the minor axis direction S.

The first and second reflecting mirrors 31 and 32 can be slanted at an angle to the minor axis directions of the screen SR, thereby preventing the reflective optical unit 30 from intercepting or obstructing the propagation of light when the thickness projection system including the projection lens unit is decreased.

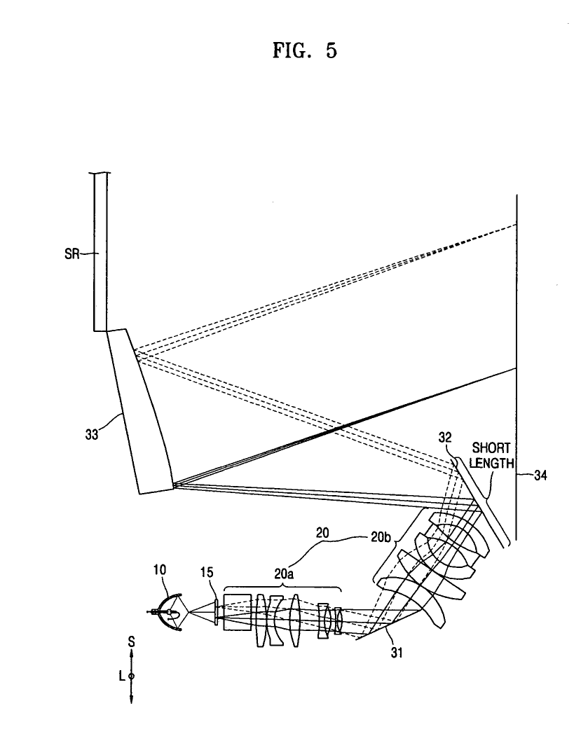

Meanwhile, referring to FIG. 5, the thickness of the projection lens unit can be adjusted by adjusting the positions and angles of the first and second reflecting mirrors 31 and 32. In this case, the first and second reflecting mirrors 31 and 32 are slanted opposite each other at the same angle. Since adjusting the positions and angles of the first and second reflecting mirrors 31 and 32 can hardly obstruct the propagation of a beam, there is no restrictions on reducing the thickness of the projection lens unit.

Referring to FIG. 3, the effective area of the second reflecting mirror 32 has the same aspect ratio as that of the display 15 and the screen SR, and a short side of the effective area of the second reflecting mirror 32 is slanted with respect to the minor axis direction S of the screen SR. The effective area refers to an area on which an effective beam is incident. The second reflecting mirror 32 has an effective area with the same aspect ratio as that of the display 15 and the screen SR.

Since the short side of the second reflecting mirror 32 extends in a path of a beam propagating toward the direction in which the second reflecting mirror 32 is slanted among beams reflected from the third reflecting mirror 33, there is little possibility that the second reflecting mirror 32 obstructs the propagation of light reflected by the second reflecting mirror 32 and then reflected by the third reflecting mirror 33 into the fourth reflecting mirror 34. Thus, the projection lens unit can be used in a projection system with a slim design without suffering from any restrictions to its construction due to the second reflecting mirror 32 even if a distance between the fourth reflecting mirror 34 and the screen SR is decreased.

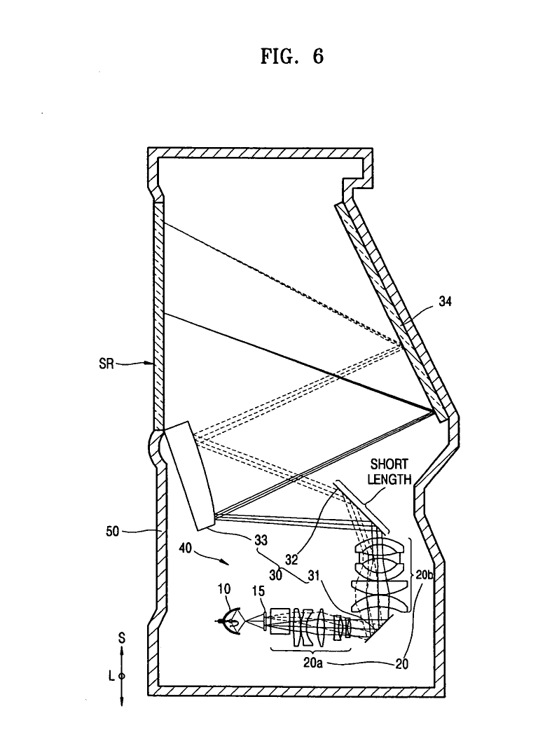

A projection system according to an embodiment of the present invention includes the projection lens unit shown in FIG. 3 and narrow, and will now be described in detail with reference to FIG. 6.

Referring to FIG. 6, the projection system includes a light source 10 located at a lower portion of a cabinet 50, a display 15 that processes light emitted by the light source 10 according to image information and produces an image, a projection lens unit 40 that enlarges the image produced by the display 15 for projection, and a screen SR onto which the image projected through the projection lens unit 40 is focused.

The projection lens unit 40 includes a refractive optical unit 20 including a plurality of lenses that enlarge the image produced by the display 15 for projection and a reflective optical unit 30 including one or more mirrors that reflect the image at an appropriate angle toward a screen SR. The screen SR has a minor axis S and a major axis L, and the refractive optical unit 30 has at least one reflecting mirror 32 tilted toward the minor axis S.

Optical axes of the refractive optical unit 20 and the reflective optical unit 30 can be coplanar. The projection lens unit 40 has the same structure as described with references to FIGS. 3 and 4, so a detailed description thereof will not be given.

The projection system is constructed with a thickness that is related to a screen size. As described above, the projection lens unit has an improved arrangement of optical components that can allow the thickness of the projection system to be minimized. The projection lens unit is constructed such that a short side of a reflecting mirror in a reflective optical unit that reflects an image produced by a display toward a screen lies in a plane perpendicular to the major axis of the screen, thereby preventing interference between light and the reflective optical unit.

Thus, the projection system including the projection lens unit can have a large screen and a slim design, and is advantageous in a projection system having an aspect ratio of 16:9. Furthermore, optical axes of the refractive optical unit and the reflective optical unit in the projection lens unit are in the same plane, thereby making optical alignment and setup easier.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A projection lens unit for enlarging and projecting a beam onto a screen having a major axis and a minor axis, the projection lens unit comprising:
a refractive optical unit including a plurality of lenses that enlarge and project an image produced by a display; and
a reflective optical unit including at least one reflecting mirror slanted with respect to the minor axis of the screen, the reflective optical unit reflecting the image passing through the refractive optical unit toward the screen.

2. The projection lens unit of claim 1, wherein optical axes of the refractive optical unit and the reflective optical unit are coplanar.

3. The projection lens unit of claim 2, wherein the optical axes of the refractive optical unit and the reflective optical unit are in a plane parallel to the minor axis of the screen.

4. The projection lens unit of claim 1, wherein each of the at least one reflecting mirror has a short side slanted toward the minor axis of the screen.

5. The projection lens unit of claim 1, wherein the refractive optical unit comprises first and second lens groups, and
wherein the reflective optical unit comprises: a first reflecting mirror that is disposed in an optical path between the first and second lens groups and changes the path of a beam passing through the first lens group; and a second reflecting mirror that is slanted with respect to the minor axis of the screen and reflects a beam passing through the second lens group.

6. The projection lens unit of claim 5, further comprising a third reflecting mirror that corrects distortion of the beam reflected from the second reflecting mirror.

7. The projection lens unit of claim 6, wherein the third reflecting mirror is an aspheric mirror.

8. A projection system in which an image produced by a display is enlarged and projected by a projection lens unit and focused onto a screen having a major axis and a minor axis, wherein the projection lens unit comprises:
a refractive optical unit including a plurality of lenses that enlarge and project the image; and
a reflective optical unit including at least one reflecting mirror slanted toward the minor axis of the screen, the reflective optical unit reflecting the image passing through the refractive optical unit toward the screen.

9. The projection system of claim 8, wherein optical axes of the refractive optical unit and the reflective optical unit are coplanar.

10. The projection system of claim 9, wherein the optical axes of the refractive optical unit and the reflective optical unit are in a plane parallel to the minor axis of the screen.

11. The projection system of claim 8, wherein each of the at least one reflecting mirror has a short side slanted toward the minor axis of the screen.
